(19) United States
(12) Patent Application Publication
(10) Pub. No.: US 2010/0217640 A1
(43) Pub. Date: Aug. 26, 2010

(54) METHOD AND SYSTEM FOR ADAPTIVE CONSTRUCTION SEQUENCING

(76) Inventor: Mark NICHOLS, Christ Church (NZ)

Correspondence Address: TRIMBLE NAVIGATION LIMITED C/O WAGNER BLECHER, 123 WESTRIDGE DRIVE, WATSONVILLE, CA, 95076, US

(21) Appl. No.: 12/390,356

(22) Filed: Feb. 20, 2009

(51) Int. Cl. G06Q 10/00; G06F 17/50; G06Q 50/00; G06Q 30/00

(52) U.S. Cl. 705/8; 703/1; 705/400

(57) ABSTRACT

A computer implemented method and computer system for adaptive construction sequencing. In one embodiment, a scheduling component is used to access a schedule for completing a project is. A 3-dimensional (3-D) simulation component is used to generate a 3-D model of at least one component used in completing the project. The 3-D simulation component is used to generate a 3-D simulation showing the construction of the project in accordance with the schedule. A cost estimating component is used to generate a cost estimate of the cost of completing the project in accordance with the schedule.

### FIELD OF THE INVENTION

Embodiments are related to the field of construction site management.

### SUMMARY

A computer implemented method and computer system for adaptive construction sequencing. In one embodiment, a scheduling component is used to access a schedule for completing a project is. A 3-dimensional (3-D) simulation component is used to generate a 3-D model of at least one component used in completing the project. The 3-D simulation component is used to generate a 3-D simulation showing the construction of the project in accordance with the schedule. A cost estimating component is used to generate a cost estimate of the cost of completing the project in accordance with the schedule.

### BRIEF DESCRIPTION OF THE DRAWINGS

The accompanying drawings, which are incorporated in and form a part of this specification, illustrate and serve to explain the principles of embodiments in conjunction with the description. Unless specifically noted, the drawings referred to in this description should be understood as not being drawn to scale.

FIG. 1 is a flowchart of a method for adaptive construction sequencing in accordance with one embodiment.

FIG. 2A is a block diagram of an example system for adaptive construction sequencing in accordance with one embodiment.

FIG. 2B shows a computer system used in accordance with one embodiment

FIG. 3 shows an example site in accordance with one embodiment.

FIG. 4 is a flowchart of a method for adaptive construction sequencing in accordance with one embodiment.

FIG. 5 is a flowchart of a method for adaptive construction sequencing in accordance with one embodiment.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. Furthermore, in the following description, numerous specific details are set forth in order to provide a thorough understanding of the subject matter. In other instances, well-known methods, procedures, objects, and circuits have not been described in detail as not to unnecessarily obscure aspects of the subject matter.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present discussions terms such as “defining,” “determining,” “generating,” “receiving,” “accessing,” “modifying,” “using” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Method and System for Adaptive Construction Sequencing

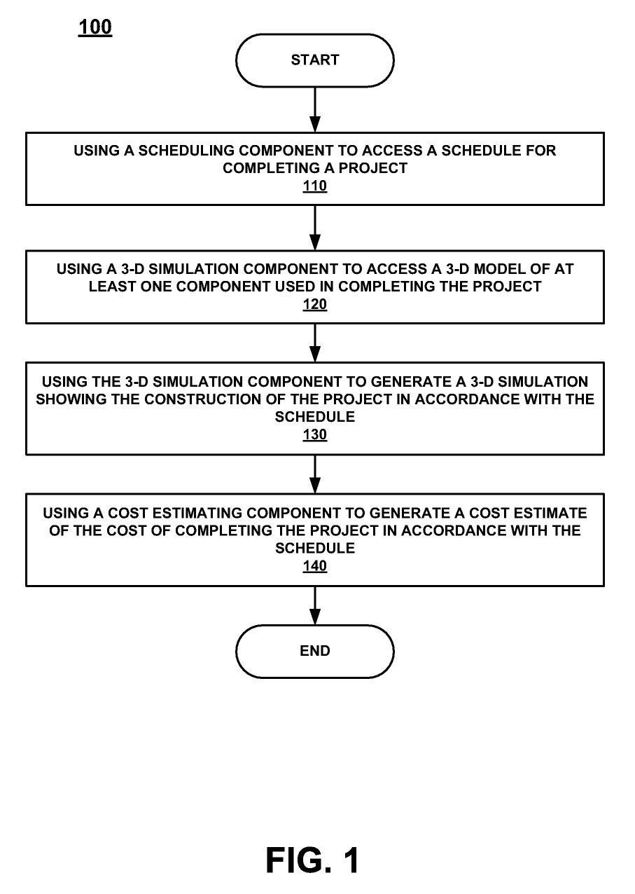

FIG. 1 is a flowchart of a method 100 for adaptive construction sequencing in accordance with one embodiment. In operation 110 of FIG. 1, a scheduling component is used to access a schedule for completing a project. In one embodiment an adaptive construction sequencing system, hereinafter referred to as “sequencing system 200” is used to generate a schedule for completing a project. In one embodiment, the schedule defines a sequence of events which are performed in completing the project. For example, to complete a road project, clearing of land, grading, building of structures, and paving of the roadway may be necessary steps in order to complete the project.

In one embodiment, sequencing system 200 generates at least one schedule in which these events are described as a specific sequence of events. In one embodiment, a user of sequencing system 200 may actually define a desired sequence of events for completing a project and sequencing system 200 will generate a schedule describing the user's desired sequence of events. In another embodiment, a user of sequencing system 200 can create a 3-dimensional (3-D) simulation of the progress of a project by placing 3-D models of components used in the project in a model of the project site. Sequencing system 200 will then generate a schedule based upon the sequence in which the 3-D models were placed in the model of the project site.

In another embodiment, a user of sequencing system 200 can create a 2-dimensional plan of the project. In one embodiment, sequencing system 200 is configured to identify components and/or operations which are needed to configure the project site in accordance with the 2-D plan created by the user. This may include contouring the project site, as well as structures that may be required to complete the project in accordance with the 2-D plan. Sequencing system 200 will then generate a schedule for completing the project in accordance with the 2-D plan created by the user.

In operation 120 of FIG. 1, a 3-dimensional (3-D) simulation component is used to access a 3-D model of at least one component used in completing the project. As described above, in one embodiment, sequencing system 200 generates at least one 3-D model of a component used to complete the project. In one embodiment, sequencing system 200 can access a defined set of parameters for the component and generate the 3-D model based upon these parameters. In one embodiment, sequencing system 200 stores parameters of components used in a project. For example, the specification for a bridge pier may describe the length, width, and height of the pier as well as other parameters. In one embodiment, sequencing system 200 is configured to access these parameters and automatically generate a 3-D model of the component. In another embodiment, sequencing system 200 can be used by a user to render the 3-D model of the component. In another embodiment, sequencing system 200 can access a stored file of the 3-D model of the component.

As described above, a user can create a 2-D plan of a project and sequencing system 200 will automatically identify components used to complete the project. In one embodiment, sequencing system 200 is configured to generate a 3-D model of the identified component. In one embodiment, sequencing system 200 may access a set of stored parameters to generate the 3-D model. As an example, sequencing system 200 may be used to create a 2-D plan of a road project. A user can create a terrain model of the site and then draw the course of the road across the terrain model. In one embodiment, sequencing system 200 is configured to automatically identify components which will be needed to complete the road project. Thus, when a curve in the road is created by the user, sequencing system 200 can access a set of parameters which define the minimum standards for a curve for the road project. These parameters may define a minimum curve radius for the intended speed limit of the road, as well as super-elevation or cross-slope of the road surface which is used to offset centripetal forces generated by vehicles in the curve. In one embodiment, sequencing system 200 identifies the curve as a component of the road project and, using the defined standards for a curve for the road project, generates a 3-D model of that component.

In operation 130 of FIG. 1, the 3-D simulation component is used to generate a 3-D simulation showing the construction of the project in accordance with the schedule. In one embodiment, sequencing system 200 creates a 3-D model of each component which comprises the project and generates a 3-D simulation showing the construction of the project based upon the sequence of events defined by the schedule accessed in operation 110. In other words, the 3-D simulation also shows the added dimension of time to portray the construction of the project. The 3-D simulation may show a portion of the project, or the entire progress of the project from start to completion. Additionally, the 3-D simulation is configured to portray the simulation from any angle and/or position which the user desires. The 3-D simulation can portray the project as a set of lines, or surfaces. Thus, in one embodiment sequencing system 200 can generate a realistic 3-D image of the project at any given point in the construction of the project. This allows a user to see what the project site will look like, at any point during the progress of the project, prior to actually beginning construction. In one embodiment, a user can color objects in the 3-D simulation to create a more realistic visual effect. Sequencing system 200 is also configured to incorporate photographs, satellite imagery, or other images in the 3-D simulation in one embodiment.

In operation 140 of FIG. 1, a cost estimating component is used to generate a cost estimate of the cost of completing the project in accordance with the schedule. In one embodiment, sequencing system 200 is configured to estimate the cost of each component used to complete the project. In one embodiment, this includes, but is not limited to, the cost of materials, pre-fabricated components, equipment costs, wages, earthworks, financing, regulatory costs, operational costs, and other factors which are incurred. More specifically, sequencing system 200 estimates the cost of completing the project based upon the sequence of events defined in the schedule described above. For example, a given project may be completed using 2 different schedules which define different sequences of events. While the events themselves may be the same, they may be performed in different sequences to complete the project. However, the sequencing of the events may impact the cost of completing the project. Thus, by comparing the cost estimates, a user can determine which schedule for the project is more cost efficient.

As an example, a construction project may involve a highway overpass in which cut material from one side of the highway is used as fill on the other side of the highway. One schedule may place the construction of the bridge portion of the overpass earlier in the sequence of events than a second schedule does. As a result, the cut material can be hauled directly over the bridge to the fill site. Using the second schedule in which construction of the bridge occurs later in the sequence of events, the cut material may have to be hauled over a longer, less direct route to the fill site. As a result, the overall time to complete the project may be increased and the cost of hauling the cut material over the longer route is likely to be much greater. Thus, the cost of the completing project may be significantly impacted by the sequence in which various events of the project are performed.

Embodiments of sequencing system 200 thus provide a system which allows a user to visualize the project site prior to actually beginning construction and identify various sequences to complete a project. The 3-D simulation generated by sequencing system 200 allows a user to easily identify an unanticipated consequence which may result from an improper sequencing of events. For example, if a project requires closing traffic in one direction, the 3-D simulation generated by sequencing system 200 allows a user to see that a given schedule does not provide a diversion of the blocked traffic. Thus, the user can modify the sequence of events in the schedule so that traffic is not blocked during the project. Sequencing system 200 provides the added advantage of identifying which schedule can potentially cost the least to implement as well as an analysis of project costs as the project progresses. As a result, a schedule which might not otherwise seem logical may actually be the best sequence of events to implement based upon the cost analysis provided by sequencing system 200. Additionally, traditional methods for completing a project can be analyzed to determine whether a more cost effective alternative method is possible.

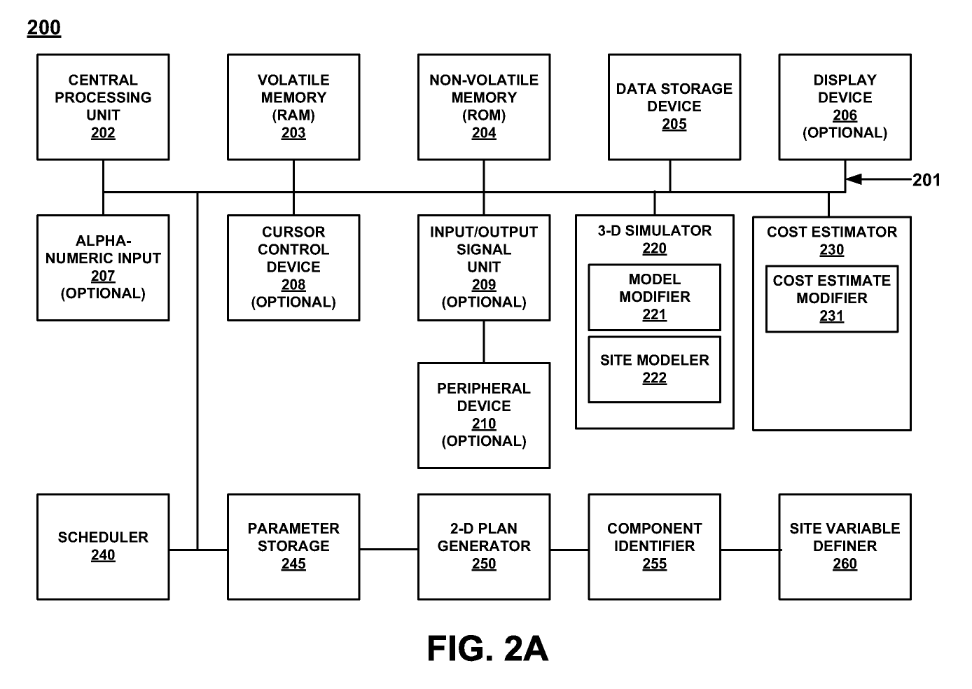

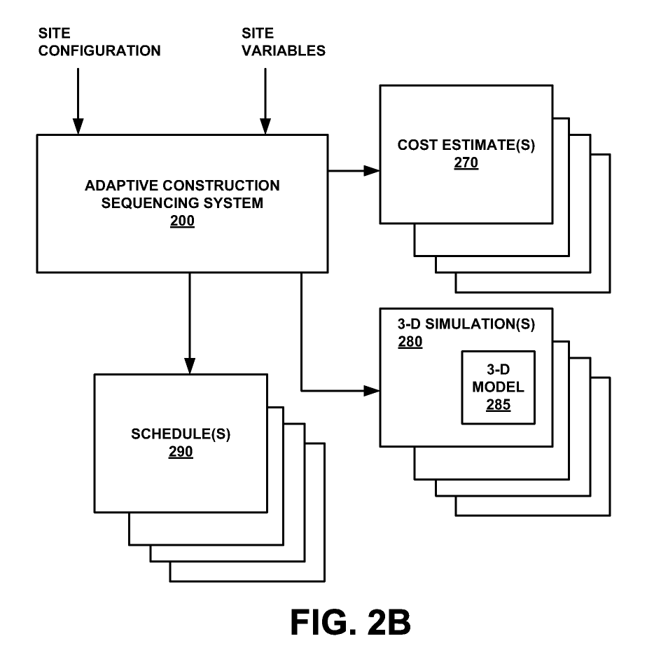

With reference to FIG. 2A, one embodiment of an adaptive construction sequencing system 200 comprises computer-readable and computer-executable instructions that reside, for example, in a computer system which is used as a part of a general purpose computer network (not shown). It is appreciated that sequencing system 200 of FIG. 2A is exemplary only and that embodiments can be implemented within a number of different computer systems including general-purpose computer systems, embedded computer systems, laptop computer systems, hand-held computer systems, and stand-alone computer systems.

In the present embodiment, sequencing system 200 includes an address/data bus 201 for conveying digital information between the various components, a central processor unit (CPU) 202 for processing the digital information and instructions, a volatile main memory 203 comprised of volatile random access memory (RAM) for storing the digital information and instructions, and a non-volatile read only memory (ROM) 204 for storing information and instructions of a more permanent nature. In addition, sequencing system 200 may also include a data storage device 205 (e.g., a magnetic, optical, floppy, or tape drive or the like) for storing vast amounts of data. It should be noted that the software program for performing adaptive construction sequencing can be stored either in volatile memory 203, data storage device 205, or in an external storage device (not shown).

Devices which are optionally coupled to sequencing system 200 include a display device 206 for displaying information to a computer user, an alpha-numeric input device 207 (e.g., a keyboard), and a cursor control device 208 (e.g., mouse, trackball, light pen, etc.) for inputting data, selections, updates, etc. Sequencing system 200 can also include a mechanism for emitting an audible signal (not shown).

Returning still to FIG. 2A, optional display device 206 of FIG. 2A may be a liquid crystal device, cathode ray tube, or other display device suitable for creating graphic images and alpha-numeric characters recognizable to a user. Optional cursor control device 208 allows the computer user to dynamically signal the two dimensional movement of a visible symbol (cursor) on a display screen of display device 206. Many implementations of cursor control device 208 are known in the art including a trackball, mouse, touch pad, joystick, or special keys on alpha-numeric input 207 capable of signaling movement of a given direction or manner displacement. Alternatively, it will be appreciated that a cursor can be directed and/or activated via input from alpha-numeric input 207 using special keys and key sequence commands. Alternatively, the cursor may be directed and/or activated via input from a number of specially adapted cursor directing devices.

Furthermore, sequencing system 200 can include an input/output (I/O) signal unit (e.g., interface) 209 for interfacing with a peripheral device 210 (e.g., a computer network, modem, mass storage device, etc.). Accordingly, sequencing system 200 may be coupled in a network, such as a client/server environment, whereby a number of clients (e.g., personal computers, workstations, portable computers, minicomputers, terminals, etc.) are used to run processes for performing desired tasks.

In FIG. 2A, sequencing system 200 further comprises a 3-D simulator 220. In the embodiment shown in FIG. 2A, 3-D simulator 220 further comprises a model modifier 221 and a site modeler 222. In one embodiment, 3-D simulator 220 comprises a graphics rendering engine which is configured to generate 3-D simulations (e.g., 280 of FIG. 2B) of a project. In one embodiment, a user can create 3-D models (e.g., 285 of FIG. 2B) of components and structures used to complete a project. For example, a bridge may require abutments at either end of the bridge, one or more piers to support the roadway, horizontal beams, and a roadway. The overall bridge project may also require access roads, ramps, earthworks, diversion roads, and other structures. In one embodiment, a user can use 3-D simulator 220 to render each of these components. In one embodiment, 3-D simulator 220 can access a library of previously rendered components and render that component as a 3-D model 285. In another embodiment, 3-D simulator 220 can access a set of parameters which define these components. For example, 3-D simulator can access the design specification for a component and render a 3-D model 285 of that component. Thus, if the design parameters for a horizontal beam define the length, width, and height of that beam, 3-D simulator 220 can access those parameters and generate a 3-D model 285 of that component. These parameters may be stored in volatile memory 203, non-volatile memory 204 data storage device 205, or parameter storage component 245 for example, or may be accessed via input/output signal unit 209. In one embodiment, 3-D simulator 220 can also generate lighting effects such as shadows, or rendering of the components at different times of the day.

In one embodiment, model modifier 221 can be used to manipulate the size, scale, and position of each 3-D model 285 it creates. Thus, a user can access a previously created 3-D model and reconfigure it according to the needs of a current project. In one embodiment, when a user changes a parameter of a component, model modifier 221 automatically modifies the 3-D model 285 in response. For example, if the stored parameters describing the thickness of a roadbed are changed, model modifier 221 will automatically modify the rendered 3-D model 285 of the roadbed to incorporate the changed thickness. As will be described in greater detail below, model modifier 221 is also configured to automatically modify a 3-D model 285 of a component in response to an indication from 2-D plan generator 250. Additionally, model modifier 221 can be used to view each 3-D model 285 from a variety of angles as desired by a user and facilitates incorporating texture and/or color to provide a more realistic representation of each object.

Site modeler 222 is used to generate a 3-D digital site plan. In one embodiment, site modeler 222 can access survey data, aerial photos, satellite data, and/or digital terrain data and create a digital terrain model of the project area. In one embodiment, site modeler 222 can incorporate data from a variety of sources (e.g., digital terrain data and aerial photos) to create a more realistic representation of the site. This includes the elevation of features of the site such as hills, ridges, valleys, depressions, and the like. Additionally, site modeler 222 can incorporate existing structures such as roads, railways, buildings, vegetation, etc. In one embodiment, site modeler 222 is configured to modify the original site plan to account for changes in the terrain due to the project. Thus, site modeler 222 can generate a series of 3-D site plans which show the terrain configuration as the project progresses.

In one embodiment, 3-D simulator 220 is configured to incorporate the 3-D models 285 described above into the digital site plan to create a 3-D simulation 280 which shows how the site will look at various stages of the project. Furthermore, the 3-D simulation 280 can incorporate the element of time so that a user can view a 3-D simulation 280 of the site at various stages of the project.

In FIG. 2A, sequencing system 200 further comprises a cost estimator 230. In the embodiment of FIG. 2A, cost estimator 230 further comprises a cost estimate modifier 231. In one embodiment, cost estimator 230 is configured to generate a cost estimate (e.g., 270 of FIG. 2B) based upon the sequence of events described in a schedule for completing a project as well as the initial configuration of the project site. In one embodiment, this may include, but is not limited to, the cost of earthworks such as terrain contouring the project site, the cost of structures and materials used in the project, the ownership and operating costs of vehicles and other equipment used on the project, wages, financing, operational costs, regulatory costs, or other factors involved in the completion of a project. In one embodiment, each cost estimate 270 is based upon a defined sequence of events in the construction of a project which are associated with a respective schedule (e.g., 290 of FIG. 2B). In other words, one cost estimate 270 is associated with a schedule 290 which defines a first sequence of events in the progress of a project. A second cost estimate 270 is associated with a second schedule 290 which defines a second sequence of events in the progress of a project. In one embodiment, each event defined in a schedule may be associated with a cost. For example, to lay a linear mile of highway may cost one million dollars. Thus, if one event defined in a schedule is to lay a linear mile of highway, this cost can be associated with the event of laying a mile of highway. In one embodiment, each event defined in a schedule is associated with a cost which is used by cost estimator 230 to generate the cost of a project.

Cost estimate modifier 231 is for modifying a cost estimate 270 in response to a change in an element of the project. For example, if the course of a roadway is changed, cost estimate modifier 231 is configured to modify an existing cost estimate 270 to account for the changes. Similarly, a change in a structure or component, a change in a sequence of events, or other factors will cause cost estimate modifier 231 to modify a cost estimate 270. In one embodiment, cost estimate modifier 231 will update an existing cost estimate 270 to account for the changes made to an associated schedule for a project. In another embodiment, cost estimate modifier 231 will retain the original cost estimate 270 and generate a second cost estimate 270 in response to a change made to an associated project. As will be discussed in greater detail below, cost estimate modifier 231 can also access site variable definer 260. Site variable definer 260 is used to define one or more variables of the project site which may have an impact on the overall cost of the project. Using site variable definer 260, cost estimate modifier 231 can modify a cost estimate to more accurately define what the cost for completing a project will be based upon conditions which may be unique to the project site.

In FIG. 2A, sequencing system 200 further comprises a scheduler 240. In one embodiment, scheduler 240 is configured to generate a schedule in which a sequence of events for completing a project is defined. In one embodiment, schedule 290 comprises a spreadsheet which identifies each component or operation which is performed in the project. Each of these components or operations is also associated with a time when that component or operation is to be completed. In one embodiment, a user can manually enter into the spreadsheet each component/operation and the time of completion. In another embodiment, a user can use 3-D simulator 220 to graphically create a simulation of the completion of the project. In other words, the user can bring 3-D models (e.g., 285) of components into a 3-D terrain model in a “drag-and-drop” operation. As an example, a user can integrate a succession of 3-D models 285 of pipeline components and link them using 3-D simulator 220. The sequence in which the 3-D models 285 are integrated into the 3-D simulation can be used by sequencing system 200 to derive a schedule 290 for integrating components of the pipeline. In one embodiment, scheduler 240 is configured to generate a schedule 290 based upon the sequence of 3-D models 285 which the user integrates into a 3-D simulation 280. In another embodiment, scheduler 240 can generate a schedule 290 based upon a sequence of 2-D models of components and/or structures which are integrated via 2-D plan generator 250.

In one embodiment, each component and/or operation performed in the completion of the project can be broken down into sub-components and sub-operations. Furthermore, sequencing system 200 can access a pre-existing schedule 290. In one embodiment, scheduler 240 is configured to modify an existing schedule to generate schedule 290. In one embodiment, each component and/or operation defined in schedule 290 further comprises an associated cost. This may be an estimated cost, or can be based upon previous projects in which a similar operation was performed.

FIG. 2A, sequencing system 200 further comprises a parameter storage component 245. As described above, in one embodiment parameter storage component 245 is used to store parameters describing one or more structures, components, or terrain components of a project. For example, a curve in a road may be defined by standards set by the government with regard to the radius of the curve and/or super-elevation of the road surface to accommodate vehicles at the design speed for the road. The roadbed itself may also be defined by mandated standards for lane width, shoulders, roadbed preparation and thickness, drainage, etc. In one embodiment, sequencing system 200 is configured access the parameters of components of a project from parameter storage component 245. In one embodiment, the parameters stored in parameter storage component 245 can be accessed by 3-D simulator 220 to generate 3-D models of components used in a project.

FIG. 2A, sequencing system 200 further comprises a 2-dimensional (2-D) plan generator 250. In one embodiment, 2-D plan generator 250 is configured to facilitate planning a project using a 2-D representation a project site. In one embodiment, 2-D plan generator 250 is used for route planning by generating a plurality of route options for a project such as a road, railroad, etc. In one embodiment, 2-D plan generator 250 accesses the terrain data as described above with reference to site modeler 222 to create a 2-D map of the project site. It is noted that terrain contours and other data can be displayed in the 2-D map generated by 2-D plan generator 250. Additionally, 2-D plan generator 250 can generate a 2-D elevation profile of a linear feature as well.

In one embodiment, a user can use drop down menus, dialog boxes, or other user interfaces to define parameters which include, but are not limited to, engineering parameters, geological features, existing features and/or structures, rules for crossing and/or integrating with existing features, restricted zones (e.g., environmentally sensitive areas), as well as the boundaries of the project site. In one embodiment, 2-D plan generator 250 will generate a cost estimate for completing a project based upon a route which a user of sequencing system 200 has identified. For example, using the parameters described above, as well as those described with reference to parameter storage component 245, 2-D plan generator 250 can identify components and/or operations which are necessary in order to complete the project using component identifier 255. In one embodiment, component identifier 255 is configured to identify structures such as bridges, culverts, retaining walls, viaducts, elevated structures, tunnels, etc. as well as an estimate of the earthworks (e.g., cut and fill operations, or other earthmoving operations) needed to complete the project. In one embodiment, 2-D plan generator 250 is configured to generate a plurality of route plans (e.g., dozens, hundreds, thousands of route plans) to facilitate identifying which route plan best implements the parameters for a project. In one embodiment, a user can manually alter the 2-D map of the project site. For example, a user can manually drag a portion of a roadway to extend a curve to a wider turn radius. In one embodiment, sequencing system 200 will automatically generate a cost estimate which shows how changing the existing plan will affect the cost of the project. In one embodiment, 3-D simulator 220 will automatically generate a 3-D model 285 of each component identified by 2-D plan generator 250 as well as a 3-D terrain model of the project site. For example, parameters of each of the components identified by 2-D plan generator 250 can be accessed from parameter storage component 245. Furthermore, cost estimator 230 can generate a cost estimate 270 based upon the structures and operations identified by 2-D plan generator 250.

FIG. 2A, sequencing system 200 further comprises a site variable definer 260. In one embodiment, site variable definer 260 is configured to define variables of a project site and available resources which may also affect the cost of the project. In one embodiment, cost estimate modifier 231 may use one or more site variables to modify a cost estimate 270 for a project. For example, the weather conditions while the project is being completed can have a significant impact on the cost of the project. In one embodiment, past weather patterns, or projected weather trends for the duration of the project, can be used by cost estimator 230 when generating cost estimate 270. Additionally, geological conditions including, but not limited to, the type of terrain (e.g., hills, wetland, desert, etc.), soil types, and depths can be used by cost estimator 230 when generating cost estimate 270. Cost estimator 230 can also factor in existing road conditions and traffic patterns, as well as road conditions and/or traffic patterns created during the project when generating cost estimate 270. This may include the traffic capacity of the roads, surface conditions, speed limits, peak traffic hours, and other factors which may affect how well materials can be moved to, from and around a project site. Additionally, traffic conditions on the project site itself can be considered when generating cost estimate 270. For example, if a foundation for a large building is being poured, it is likely that traffic on the project site will increase compared with other times due to the large number of concrete mixers which will be traversing the project site. Additionally, the projected delivery times of other materials can affect the amount of traffic on a project site and can also be factored into cost estimate 270.

Cost estimator 230 can also factor in available vehicles and/or other equipment used on the project when generating cost estimate 270. This may also include performance parameters of each vehicle such as load carrying capacity, operating speeds, ownership and operating costs per vehicle, the relative efficiency of a vehicle at performing a given task, and other factors which may affect the cost of the project. Additionally, the availability of rental equipment can be factored into cost estimate 270. Similarly, the availability of equipment may vary at different times in the project can be factored into cost estimate 270. For example, a paving machine may be available at an earlier stage in the project and not available, or available at a higher cost, later in the course of the project. This may affect not only the sequence of events in a schedule, but the cost of the project as well. Thus, if a certain piece of equipment is not available at a given time, sequencing system 200 can generate a message to prevent generating a schedule which requires that equipment at that given time. Similarly, a user can schedule different mixes of equipment to determine whether it is beneficial to the project. For example, if a user wants to complete the earthworks portion of the project as soon as possible, the user can define different mixes of earthmoving equipment to determine an optimal mix for moving the soil quickly and economically. The user can then designate a different mix of vehicles for later phases of the project. Thus, using sequencing system 200, a user can optimize the mix a vehicles at the project site for each phase of the project and generate an analysis of the financial impact of that vehicle mix on the cost of the project.

Other site variables used by cost estimator to generate cost estimate 270 may include parameters of materials at the project site. For example, if it has been raining recently and a project involves extensive earthmoving operations, it will be more expensive and time consuming to move wet soil than if the soil is dry. This information can be estimated based upon recent weather patterns, or based upon measured soil moisture content. Thus, a user may elect to defer some earthmoving operations until the soil has dried out based upon an analysis generated by sequencing system 200. Cost estimator 230 can also factor in how far materials have to be moved on the project site. For example, if soil can be moved from one part of the project site and used at another, the project will cost less than if the soil has to be trucked offsite and dumped at another location. Additionally, sometimes soil may sometimes have to be handled in a special manner if toxins or other environmental risks are detected and can be factored into cost estimate 270. Also, the speed at which materials can be moved can be factored into cost estimate 270. For example, the load capacity and maximum operating speed of one type of dump truck relative to another type may affect the cost of the project. Additionally, if the vehicles have to move over unimproved roads, or steep grades, it will reduce the ability to move materials.

Cost estimator 230 can also factor in which equipment operators will be working at the project site and their wages. For example, some operators may be sick, on vacation, or otherwise unavailable at a point in the project. Additionally, operator availability impacts wages as a comparison of the benefits of working one or more operators at overtime wages rather than ordinary wages may be considered. Operator availability may also affect how quickly benchmarks in the progress of the project can be completed. Additionally, the productivity of a particular operator may affect the status of a project. It is possible to collect data which reflects the productivity of employees at a site and use this data to determine how it will affect the status of the project in the future. For example, a less skilled operator of an excavator may only perform 75% of the workload which can be performed by a more experienced operator. This in turn affects how much material can be moved at a site and how long it will take to move it.

In one embodiment, site variable definer 260 is further configured to define other factors which may affect the cost of the project. For example, for a given project, a bonus may be paid for completing the project ahead of schedule and a penalty is incurred for completing the project later than projected. Thus, it may be beneficial to work some, or all, of the employees at the project site overtime in order to earn the bonus for completing the project ahead of schedule. Other factors may include, but are not limited to, scheduled delivery of materials and/or components, cash flow, cash reserves, financing, regulatory costs, operational costs, costs of materials, etc. which may be incurred during the progress of the project. In one embodiment, cost estimator 230 can use this data when generating cost estimate 270. Thus, cost estimator 230 provides a useful financial analysis for comparing various schedules and determining which schedules are economically beneficial.

It is noted that while some components are described above as being implemented as computer-readable and computer-executable instructions, other embodiments may implement computer hardware and/or firmware or a combination thereof to implement the same functionality. This may include, but is not limited to, 3-D simulator 220, cost estimator 230, scheduler 240, parameter storage 245, 2-D plan generator 250, component identifier 255, and site variable definer 260. Additionally, the functionality of the components described above may be integrated in accordance with embodiments.

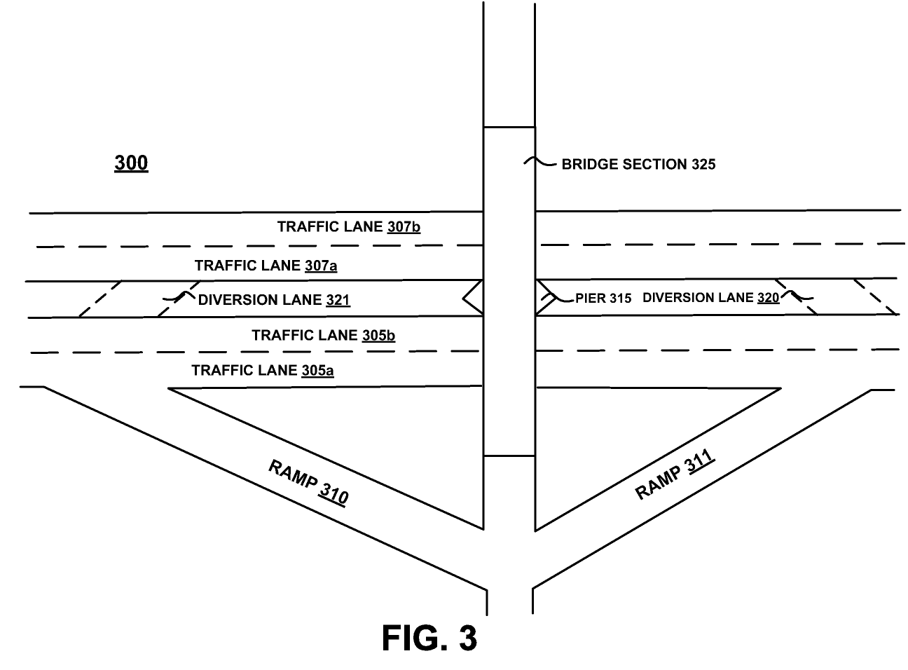

FIG. 3 shows an example site 300 in accordance with one embodiment. In FIG. 3, site 300 comprises a divided highway in which traffic lanes 305a and 305b carry traffic in one direction and traffic lanes 307a and 307b carry traffic in the other direction. The project which is being planned using sequencing system 200 comprises a bridge section 325 which is to cross over the divided highway. Also being built in the project are a ramp 310 and ramp 311 for carrying traffic off of, or onto, traffic lane 305a. A pier 315 will also be built during the project to support bridge section 325. In one embodiment, a user defines one or more site variables as described above with reference to FIG. 2A.

The user can also use 3-D simulator 220 to render 3-D models 285 of components of project site 300 such as bridge section 325, or components thereof such as steel beams which will support a roadway of the bridge section, sidewalks, drainage structures, etc. The user can also use 3-D simulator 220 to render 3-D models 285 of other components such as pier 315, ramp 310 and ramp 311, or diversion lanes 321 and 320. Alternatively, these components can be rendered by 3-D simulator 220 by accessing a file of stored models, accessing parameters descriptive of these components via parameter storage component 245, or using 2-D plan generator 250 to identify those components and then accessing the parameters of the components via parameter storage component 245.

The user can also use scheduler 240 to define at least one schedule 290 in which the sequence of constructing these components is defined. For example, a first schedule 290 may indicate that pier 315 is built first. Then ramps 310 and 311 will be built, followed by bridge section 325. Cost estimator 230 will then generate a corresponding cost estimate 270 which describes the cost of building the bridge project in accordance with the sequence of events defined in the first schedule. A second schedule 290 may be generated to determine whether closing traffic lane 305b and/or 307a is desired. This may be desirable in order to expedite the completion of pier 315. Cost estimator 230 will then generate a corresponding cost estimate 270 which describes the cost of building the bridge project in accordance with the sequence of events defined in the second schedule. The second cost estimate 270 will factor in the impact of closing traffic lane 305b and traffic lane 307a on the cost of the project.

A third schedule may be generated using scheduler 240 in which diversion lanes 320 and 321 are first built followed by the sequence described above with reference to the first schedule. This will facilitate closing traffic lanes 305a and 305b simultaneously in order to expedite the building of pier 315. Again, the third cost estimate 270 will factor in the impact of closing traffic lane 305a and traffic lane 305b on the cost of the project. A fourth schedule may be generated using scheduler 240 in which pier 315 will be built later in the sequence of events so that closing of traffic lane 305b and traffic lane 307a occurs during a period when traffic is expected to be lower such as a holiday weekend. Cost estimator 230 will generate a fourth cost estimate 270 which will factor in the impact of closing traffic lane 305b and traffic lane 307a on the cost of the project. However, the cost impact on the project due to closing traffic lanes 305b and 307a may be different than that of the second scenario due to the lower amount of traffic when the lanes are closed.

In one embodiment, sequencing system 200 will access each of the schedules 290 and generate corresponding 3-D simulations 280 and cost estimates 270. In one embodiment, cost estimator 230 will generate a cost estimate for each portion of the project, and cost estimate modifier 231 can modify the cost estimate based upon site variables as discussed above. For example, the cost of laying a linear mile of highway can be accurately predicted based upon previous experience. Additionally, one or more variables described above can be factored into the cost estimate of laying the highway to more accurately predict the cost of laying the road based upon actual and/or predicted conditions at the project site. Again, the sequence of events which occur at the project site also affects the overall cost of the project and is factored into the respective cost estimate generated by sequencing system 200.

3-D simulator 220 will generate 3-D models of each component identified and generate a 3-D simulation showing the progress of the project based upon the sequence of events defined by particular schedule. Thus, the user can view the project site in a 3-D environment at various stages in the project and see whether the sequence of events defined in the schedule is desirable. For example, if traffic lanes 305a and 305b are to be closed prior to installing pier 315, a user can see from viewing 3-D simulation 280 whether the building of diversion lanes 320 and 321 has been correctly sequenced ahead of closing the traffic lanes. Other sequences of events may not be as readily apparent as the building of diversion lanes without the use of 3-D simulation 280.

Thus, using sequencing system 200 a user can analyze various options for completing a project which not only give a spatial/temporal analysis of a project, but a cost analysis as well. As a result, a user can quickly determine whether a particular schedule for completing a project is logically sound, but is also financially advantageous as well. Because the user can define site variables which may be particular to a given site, a more detailed cost estimate can be generated using sequencing system 200. Using sequencing system 200, a user can evaluate the cost impact of different decisions as to how to complete the project and can evaluate the impact of site changes from a quantitative cost perspective. More specifically, the site variables allow a user to determine more precisely what the economic impact will be on the project as a result of changing the sequence of events at the project site. Additionally, the user can analyze whether existing methods for completing a project generate the greatest profits, or whether a different sequence of events will be more profitable.

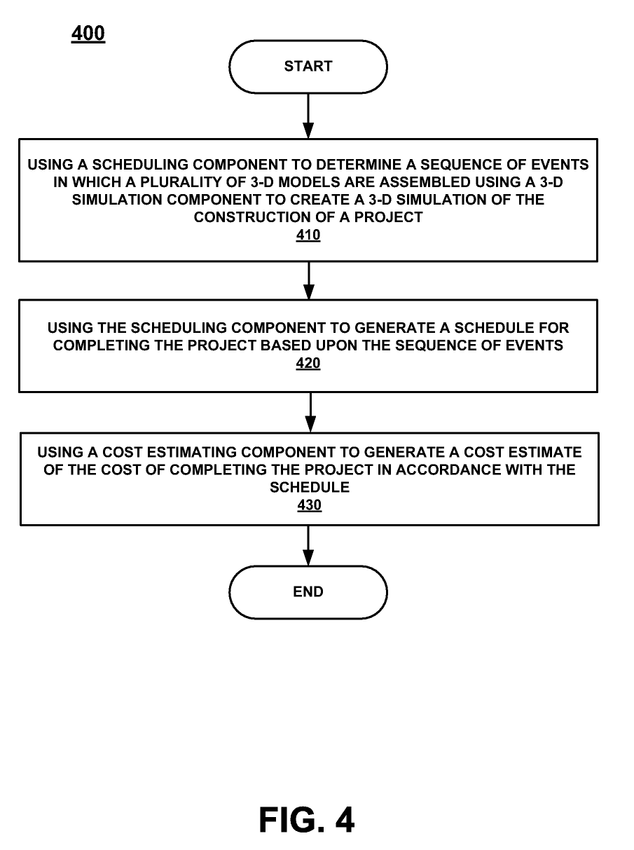

FIG. 4 is a flowchart of a method 400 for adaptive construction sequencing in accordance with one embodiment. In operation 410 of FIG. 4, a scheduling component is used to determine a sequence of events in which a plurality of 3-D models are assembled using a 3-D simulation component to create a 3-D simulation of the construction of a project. As described above, in one embodiment a user “assembles” a project by placing 3-D models of project components into a digital terrain model of the project site. For example, referring again to FIG. 3, a user can create, or access a previously stored, digital terrain model of site 300 using 3-D simulator 220. The digital terrain model includes the present conformation of the terrain such as elevations, etc. as well as the existing traffic lanes of the divided highway. Using 3-D simulator 220, the user accesses 3-D models of components of the bridge project and places them into the digital terrain model. For example, the user may first place a 3-D model of pier 315 into the digital terrain model, followed by 3-D models of ramp 310, ramp 311, and the various components of bridge structure 325. Thus, the 3-D simulation 280 created by the user comprises the digital terrain model as well as the 3-D models which are brought into the simulation in a particular sequence. In one embodiment, the sequence in which the 3-D models are placed into the digital terrain model is used to determine a sequence of events for completing the actual bridge project.

In operation 420 of FIG. 4, a scheduling component is used to generate a schedule for completing the project based upon the sequence indicated in operation 410 above. In response to the sequence in which the 3-D models are placed into the digital terrain model, scheduler 240 creates a schedule 290 which defines the sequence of events which will occur at the actual project site. The schedule 290 defines the sequence of events at the project site in the same order as that performed with reference to operation 410 above. In other words, in the schedule 290, the pier 315 is scheduled to be completed first, followed by the completion of ramp 310 and ramp 311. Finally, the various components of bridge structure 325 are completed. The use of 3-D simulator 220 to indicate the sequence in which operations at the project site provides a very intuitive method for generating a project schedule. For example, a user can readily identify whether a given operation will conflict with other events taking place at the site when using a 3-D simulation to initiate generating a schedule. Alternatively, using a text or spreadsheet editor alone to generate a schedule, a user may not readily recognize when certain events in a schedule will conflict with other events that are occurring. This is especially problematic in larger projects involving dozens of steps or benchmarks and in which a user may find it difficult to track all of the events and whether they are scheduled in a logical sequence. However, 3-D simulator 220 allows a user to more readily identify conflicts and correct the schedule.

In operation 430 of FIG. 4, a cost estimating component is used to generate a cost estimate of the cost of completing the project in accordance with the schedule. As described above, cost estimator 230 is configured to access the schedule 290 and generate a corresponding cost estimate 270 based upon the sequence of events defined by schedule 290. As an example, each of the events may be associated with a respective cost. In one embodiment, each event is associated with an estimated cost. For example, if it costs 1 million dollars to lay a linear mile of highway, and one event of a project comprises laying a half mile segment of highway, a reasonable estimate of the cost of that event is one half million dollars. However, this estimate may not account for the particular conditions at the project site. Using cost estimate modifier 231, the site variables can be accessed via site variable definer 260 to more precisely determine what the actual cost will be for laying one half mile of highway based upon the conditions at the project site. As an example, if extensive cut/fill operations are required to prepare the roadbed, the cost of laying one half mile of highway will be greatly increased. Additionally, if the highway passes through or near an environmentally sensitive area, the cost of laying the highway will be increased. As discussed above, site variable definer 260 allows a user to accurately describe the actual conditions in which the project will be completed to facilitate generating a more precise estimate of the cost to complete the project. The economic impact of these site variables may not be readily apparent to a user, especially since they often depend upon each other. For example, a delay in the completion of earthworks may affect the price to rent paving equipment for a site and may necessitate working some crews overtime in order to complete the project on time.

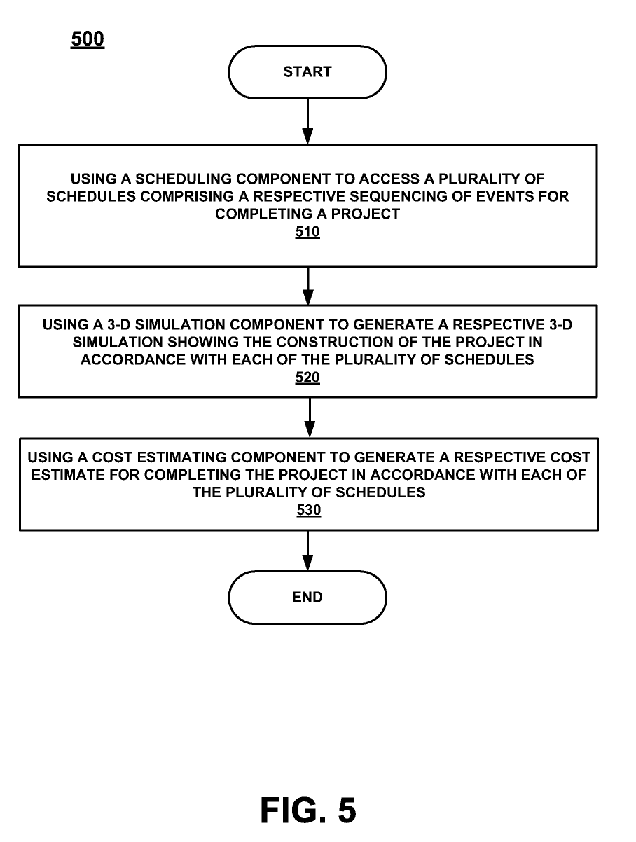

FIG. 5 is a flowchart of a method 500 for adaptive construction sequencing in accordance with one embodiment. In operation 510 of FIG. 5, a scheduling component is used to access a plurality of schedules comprising a respective sequence of events for completing a project. In one embodiment, a plurality of schedules 290 is generated by sequencing system 200. This facilitates comparing the various schedules to determine which one is more efficient and cost effective. As discussed above, the schedules 290 can be generated using a spreadsheet program, word editor, or 3-D simulator 220 to indicate the desired sequence of events.

In operation 520 of FIG. 5, a 3-D simulation component is used to generate a respective 3-D simulation showing the construction of the project in accordance with each of the plurality of schedules. In one embodiment, a respective 3-D simulation 280 is generated for each schedule 290 generated by sequencing system 200. This facilitates determining whether the sequence of events defined by a given schedule progresses in a logical and/or efficient manner. This also facilitates discovering potential conflicts in the sequencing of events. Additionally, a user can view how the project will appear at various times during the progress of the project.

In operation 530 of FIG. 5, a cost estimating component is used to generate a respective cost estimate for completing the project in accordance with each of the plurality of schedules. As discussed above, cost estimator 230 generates a respective cost estimate 270 corresponding to one of the schedules accessed above in operation 510. Furthermore, sequencing system 200 is configured to generate detailed cost estimates which give a clear indication of the impact that different schedules can have upon a project's overall cost as well as the an analysis of the day to day financial state of the project.

Embodiments of the present technology are thus described. While the present technology has been described in particular embodiments, it should be appreciated that the present technology should not be construed as limited by such embodiments, but rather construed according to the following claims.

What is claimed is:

1. A computer implemented method for adaptive construction sequencing, said method comprising:
using a scheduling component to access a schedule for completing a project;
using a 3-D simulation component to access a 3-dimensional (3-D) model of at least one component used in completing the project;
using said 3-D simulation component to generate a 3-D simulation showing the construction of the project in accordance with said schedule; and
using a cost estimating component to generate a cost estimate of the cost of completing the project in accordance with said schedule.

2. The method as recited in claim 1 further comprising:
using said scheduling component to generate a plurality of schedules for completing the project;
using said 3-D simulation component to generate a plurality of 3-D simulations wherein at least one of said plurality of 3-D simulations shows the construction of the project in accordance with a respective schedule of said plurality of schedules; and
using said cost estimating component to generate a plurality of cost estimates wherein at least one of said plurality of cost estimates describes the cost of completing the project in accordance with one of said plurality of schedules.

3. The method as recited in claim 1 further comprising:
accessing a set of parameters defining said component using said 3-D simulation component; and
generating said 3-D model based upon said set of parameters using said 3-D simulation component.

4. The method as recited in claim 3 further comprising:
receiving an indication to modify one of said set of parameters defining said component; and
modifying said cost estimate based upon said receiving said indication using said cost estimating component.

5. The method as recited in claim 1 further comprising:
accessing a 2-dimensional (2-D) plan of the project using a 2-D plan generating component;
using said 2-D plan to identify said at least one component; and
generating said 3-D model of said at least one component using said 3-D simulation component.

6. The method as recited in claim 5 further comprising:
receiving an indication to modify said 2-D plan;
determining that at least one parameter of said at least one component is changed as a result of said receiving of said indication;
modifying said 3-D model based upon said determining using said 3-D simulation component; and
modifying said cost estimate using said cost estimating component.

7. The method as recited in claim 1 further comprising:
accessing a description of the configuration of a site at which the project is to be completed; and
using said description to generate said cost estimate using said cost estimating component.

8. The method as recited in claim 7 further comprising:
using a site variable defining component to define at least one variable of the site selected from the group consisting of: a distance to move the material from said first location to said second location of the site, a road condition between said first location and said second location of the site, how fast the material can be moved from said first location to said second location of the site, a time when the material is moved from said first location to said second location of the site, and a weather variable.

9. The method as recited in claim 8 further comprising:
using said site variable defining component to define at least one resource available for completing the project.

10. A computer implemented method for adaptive construction sequencing, said method comprising:
using a scheduling component to determine a sequence of events wherein a plurality of 3-dimensional (3-D) models of components is assembled using a 3-D simulation component to create a 3-D simulation of the construction of a project;
using said scheduling component to generate a schedule for completing the project based upon said sequence; and
using a cost estimating component to generate a cost estimate of the cost of completing the project in accordance with said schedule.

11. The method as recited in claim 10 further comprising:
using said scheduling component to determine a plurality of sequences wherein a plurality of 3-D models of components is assembled to create a plurality of 3-dimensional (3-D) simulations of the construction of a project;
using said scheduling component to generate a plurality of schedules for completing the project based upon said plurality of sequences; and
using a cost estimating component to generate a plurality of respective cost estimates of the cost of completing the project in accordance with said plurality of schedules.

12. The method as recited in claim 10 further comprising:
using said 3-D simulation component to access a set of parameters defining at least one component of said plurality of components; and
using said 3-D simulation component to generate a 3-D model of said at least one component based upon said set of parameters.

13. The method as recited in claim 12 further comprising:
receiving an indication to modify one parameter of said set of parameters defining said at least one component; and
using said cost estimating component to generate to modify said cost estimate based upon said receiving said indication.

14. The method as recited in claim 10 further comprising:
accessing a 2-dimensional (2-D) plan of the project;
using said 2-D plan to identify said at least one component of said plurality of components; and
using said 3-D simulation component to generate a 3-D model of said at least one component.

15. The method as recited in claim 10 further comprising:
receiving an indication to modify a 2-D plan;
determining that at least one parameter of said at least one component is changed as a result of said receiving of said indication;
using said 3-D simulation component to modify said 3-D model based upon said determining; and
using said cost estimating component to modify said cost estimate.

16. The method as recited in claim 10 further comprising:
accessing a description of the configuration of a site at which the project is to be completed; and
said cost estimating component using said description to generate said cost estimate.

17. The method as recited in claim 16 further comprising:
using a site variable defining component to define at least one variable of the site selected from the group consisting of: a distance to move the material from said first location to said second location of the site, a road condition between said first location and said second location of the site, how fast the material can be moved from said first location to said second location of the site, a time when the material is moved from said first location to said second location of the site, and a weather variable.

18. The method as recited in claim 17 further comprising:
using said site variable defining component to define at least one resource available for completing the project.

19. A computer implemented method for adaptive construction sequencing, said method comprising:
using a scheduling component to access a plurality of schedules comprising a respective sequence of events for completing a project;
using a 3-D simulation component to generate a respective 3-dimensional (3-D) simulation showing the construction of the project in accordance with each of said plurality of schedules; and
using a cost estimating component to generate a respective cost estimate for completing the project in accordance with each of said plurality of schedules.

20. The method as recited in claim 19 further comprising:
using said 3-D simulation component to generate a 3-D model of at least one component of the project; and
using said 3-D model of said at least one component when generating said respective 3-dimensional (3-D) simulation by said 3-D simulation component.

21. The method as recited in claim 20 further comprising:
accessing a set of parameters defining said at least one component; and
using said 3-D simulation component to generate a 3-D model of said at least one component based upon said set of parameters.

22. The method as recited in claim 21 further comprising:
receiving an indication to modify one parameter of said set of parameters defining said at least one component; and
using said cost estimating component to modify said cost estimate based upon said receiving said indication.

23. The method as recited in claim 19 further comprising:
accessing a 2-dimensional (2-D) plan of the project;
using said 2-D plan to identify said at least one component; and
using said 3-D simulation component to generate a 3-D model of said at least one component.

24. The method as recited in claim 23 further comprising:
receiving an indication to modify said 2-D plan;
determining that at least one parameter of said at least one component is changed as a result of said receiving of said indication;
using said 3-D simulation component to modify said 3-D model based upon said determining; and
using said cost estimating component to modify said cost estimate.

25. The method as recited in claim 19 further comprising:
accessing a description of the configuration of a site at which the project is to be completed; and
using said description to generate said cost estimate by said cost estimating component.

26. The method as recited in claim 25 further comprising:
using a site variable defining component to define at least one variable of the site selected from the group consisting of: a distance to move the material from said first location to said second location of the site, a road condition between said first location and said second location of the site, how fast the material can be moved from said first location to said second location of the site, a time when the material is moved from said first location to said second location of the site, and a weather variable.

27. The method as recited in claim 26 further comprising:
using said site variable defining component to define at least one resource available for completing the project.

28. A system comprising;
a scheduler component configured to generate a schedule for completing a project;
a 3-dimensional (3-D) simulation component configured to generate a 3-D simulation showing the construction of the project in accordance with said schedule; and
a cost estimate generating component configured to generate a cost estimate of the cost of completing the project in accordance with said schedule.

29. The system of claim 28 wherein said 3-D simulation component is further configured to generate a 3-D model of at least one component of the project.

30. The system of claim 29 further comprising:
a parameter storage component configured to store a set of parameters defining said at least one component; and
said 3-D simulation component which is further configured to generate said 3-D model based upon said set of parameters.

31. The system of claim 30 wherein said 3-D simulation component further comprises:
a model modification component configured to modify said 3-D model in response to receiving an indication to modify one of said set of parameters defining said at least one component; and
wherein said cost estimate generating component further comprises a cost estimate modifying component configured to modify said cost estimate in response to modifying one of said set of parameters.

32. The system of claim 30 further comprising:
a 2-dimensional (2-D) plan generator configured to generate a 2-D plan of the project; and
a component identifier configured to identify said at least one component based upon said 2-D plan of the project and wherein said 3-D simulation component is further configured to generate said 3-D model based upon said identification.

33. The system of claim 32 wherein said 3-D simulation component further comprises:
a model modification component configured to modify said 3-D model in response to receiving an indication to modify one of said set of parameters defining said at least one component; and
wherein said cost estimate generating component further comprises a cost estimate modifying component configured to modify said cost estimate in response to modifying one of said set of parameters.

34. The system of claim 28 wherein said 3-D simulation component further comprises:
a site modeling component configured to generate a 3-D model of the configuration of a site at which the project is to be completed.

35. The system of claim 34 further comprising:
a site variable defining component configure to define at least one variable of the site selected from the group consisting of a distance to move the material from said first location to said second location of the site, a road condition between said first location and said second location of the site, how fast the material can be moved from said first location to said second location of the site, a time when the material is moved from said first location to said second location of the site, and a weather variable.

36. The system of claim 35 further comprising:
a resource definition component configured to define a set of available resources for the project.

37. The system of claim 28 wherein said scheduler component is further configured to generate a plurality of schedules for completing the project, said 3-D simulation component is further configured to generate a plurality of 3-D simulations wherein each of said plurality of 3-D simulations shows the construction of the project in accordance with a respective schedule of said plurality of schedules and said cost estimate generating component is further configured to generate a plurality of cost estimates which respectively describe the cost of completing the project in accordance with one of said plurality of schedules.
